(19) United States
(12) Patent Application Publication
(10) Pub. No.: US 2009/0006857 A1
(43) Pub. Date: Jan. 1, 2009

(54) METHOD AND APPARATUS FOR STARTING UP A COMPUTING SYSTEM

(76) Inventor: Anton Cheng, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/772,047

(22) Filed: Jun. 29, 2007

(51) Int. Cl. H04L 9/32; G06F 7/04

(52) U.S. Cl. 713/183; 726/19

(57) ABSTRACT

A computer system may be powered up or awakened from a power-saving state with one single user action. An authentication device may be used to detect a user action and to collect data from the user action. An authentication module may be used to authenticate a user based on the data collected by the authentication device. A controller may enable a user to access a non-volatile storage medium for user credentials necessary to power up or awaken the computer system.

### BACKGROUND

1. Field

This disclosure relates generally to computer systems, and more specifically but not exclusively, to methods and apparatus for starting up a computing system.

2. Description

Most computing systems nowadays have many security features including features for preventing unauthorized users from starting up or accessing data in a computer system. For example, a computer system may have a BIOS (basic input and output system) password, an HDD (hard disk drive) password, a HDD encryption key, an OS (operating system) sign-on password, and so on. Typically a user may need several passwords, tokens, and/or identify keys to start up, wake up, and/or access data in a computer system. This not only slows down the process of staring up, waking up, or accessing a computer system, but also is a burden for a user to remember and/or carry so much information in order to use a computer system. Thus, it is desirable to simply and speed up the process for starting up, waking up, and/or accessing a computer system.

### BRIEF DESCRIPTION OF THE DRAWINGS

The features and advantages of the disclosed subject matter will become apparent from the following detailed description of the subject matter in which:

FIG. 1 shows a block diagram of a computer system where an embodiment of the subject matter disclosed in the present application may be implemented; and

FIG. 2 shows a flowchart of an example process for simplifying powering up a computer system or resuming the system from a power-saving state, according to an embodiment of the subject matter disclosed in the present application.

### DETAILED DESCRIPTION

According to embodiments of the subject matter disclosed in this application, a computer system may be powered up or awakened from a power-saving state with one single user action. An authentication module may be combined with a power-on switch of a computer system. The authentication module and other components that support the module may be provided with power by an auxiliary power source independent from the power source that supports main components (e.g., processor, chipset, input/output devices, radio frequency (“RF”) device, and so on) of a computer system. A user may trigger the authentication module to perform the user authentication process with a single user action such as, for example, a finger print scan and/or a blue tooth token. Once the user is authenticated, the main components of the computer system may be powered on and user credentials may be accessed. All necessary passwords, tokens or other identity keys may be retrieved from the user credentials to enable the user to start up/wake up the system and access data in the system.

Reference in the specification to “one embodiment” or “an embodiment” of the disclosed subject matter means that a particular feature, structure or characteristic described in connection with the embodiment is included in at least one embodiment of the disclosed subject matter. Thus, the appearances of the phrase “in one embodiment” appearing in various places throughout the specification are not necessarily all referring to the same embodiment.

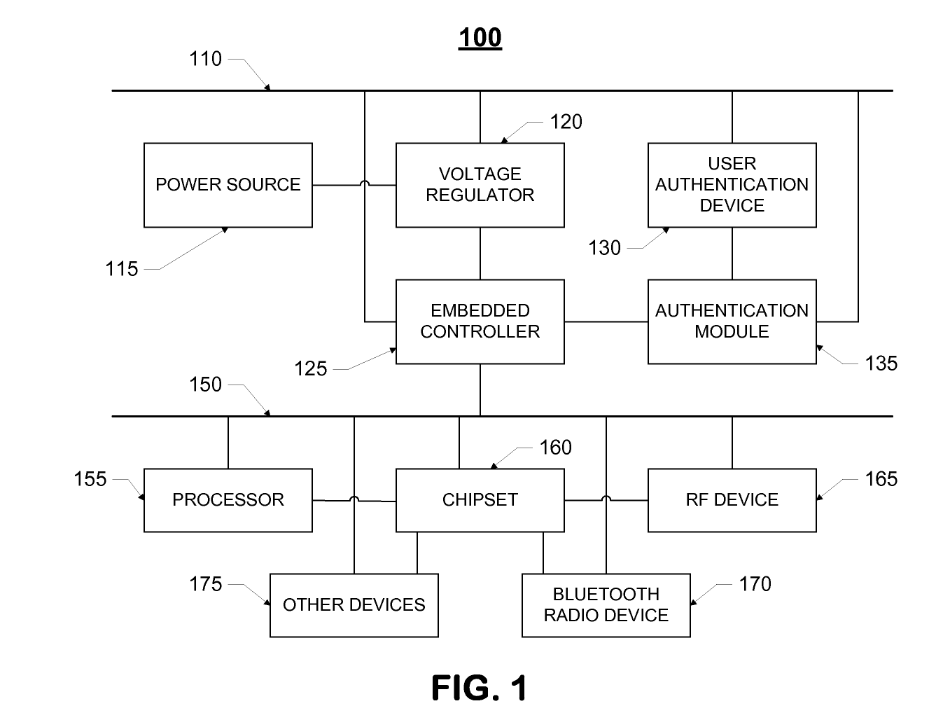

FIG. 1 shows a block diagram of a computer system 100 where an embodiment of the subject matter disclosed in the present application may be implemented. As a typical computer system, system 100 includes at least one processor 155 which is coupled to a chipset 160 via a system bus. Devices such as RF device 165, Bluetooth radio device 170, and other devices 175 may be coupled to chipset 160 through a Peripheral Component Interconnect (PCI) bus or other types of connections. Processor 155, chipset 160, RF device 165, Bluetooth radio device 170 and other devices 175 may be powered through one or more platform power rails 150. The power of the platform power rails are supplied from power source 115 through a voltage regulator 120, which may regulate and/or stabilize voltage for platform power rails 150.

In addition to those components that a typical computer system has, computer system 100 may comprise a user authentication device 130, an authentication module 135, and an embedded controller 125. In one embodiment, voltage regulator 120, user authentication device 130, embedded controller 125, and authentication module 135 may be powered by an auxiliary power rail 110. In another embodiment, only user authentication device 130 may be powered by auxiliary power rail 110; and other components such as voltage regulator 120, embedded controller 125, and authentication module 135 may be powered by platform power rails 150. Power for auxiliary power rail may be supplied by an auxiliary power source (not shown in the figure) which is independent from power source 115. Auxiliary power source may be battery and other power sources that supplies power to auxiliary power rail 110 at least during times when computer system 100 is powered off or in a power-saving state.

User authentication device 130 may detect a user action and collect data from the user action to authenticate the user. For example, user authentication device 130 may include a fingerprint sensor, a voice based user identification device, a smart card reader, any device that serves the purpose of authenticating a user, or any combination thereof. In one embodiment, user authentication device 130 may be coupled with a power-on switch (not shown in the figure) of computer system 100. Once user authentication device detects a user action, the power-on switch may be triggered and system 100 may be powered on.

Authentication module 135 may be implemented either by hardware or software, or a combination thereof. Authentication module 135 may receive data about the user from authentication device 130 and perform pattern recognition by comparing the received data about the user with one or more pre-stored templates. If the received data about the user matches one template, authentication module may send a pass signal to embedded controller 125; otherwise a fail signal is sent to embedded controller 125.

If embedded controller 125 receives a pass signal from authentication module 135, it may access a storage medium that stores credentials of this user. The user credentials may include information necessary for the user to power up, wake up, and/or access data in computer system 100. For example, the user credentials may include a BIOS password, an HDD password, an HDD encryption key, and other tokens or passwords of the user. Embedded controller 125 may further retrieve such passwords/tokens according to an order required to power up, wake up, or access data in computer system 100. Typically, the storage medium that stores the user credentials should be non-volatile. If embedded controller 125 receives a fail signal from authentication module 135, on the other hand, embedded controller may prompt the user for a retry until the number of retry reaches or exceeds a predetermined limit.

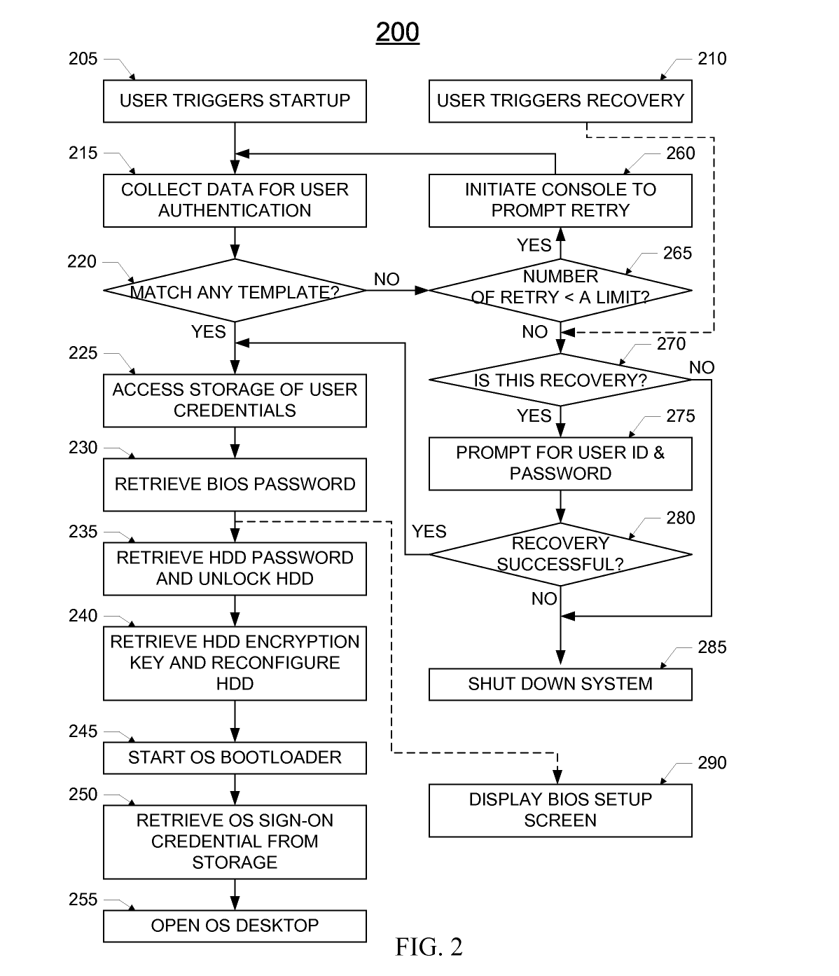

FIG. 2 shows a flowchart of an example process 200 for simplifying powering up a computer system or resuming the system from a power-saving state, according to an embodiment of the subject matter disclosed in the present application. At block 205 or block 210, a user may trigger startup or recovery of a computer system through an action. At block 215, data may be collected for user authentication. At block 220, it may be determined whether data collected at block 215 matches a pre-stored template. If the answer is “yes,” the storage medium that stores user credentials may be accessed at block 225. At block 230, a BIOS password may be retrieved from the storage medium so that the BIOS of the computer system may be activated. Once the system BIOS is activated, the user has an option to access the BIOS setup screen at 290 from which the user may change one or more BIOS setup parameters. At block 235, an HDD password may be retrieved so that the HDD of the system may be unlocked. At block 240, an HDD encryption key (if there is any) may be retrieved so that the HDD may be reconfigured.

At block 245, the OS boot loader may be started. At block 250, OS sign-on credential may be retried from the storage medium for the user credentials. At block 255, an OS desktop may be opened for the user so that the user can work on the computer system directly.

If at block 220, it is determined that no template matches the date collected at block 215 about the user, it may be further determined at block 265 whether the number of user retry has reached or exceeded a predetermined limit. If the answer is “yes,” the user may be prompted for a retry; otherwise, it may be further determined whether the system needs recovery from a power-saving state based on the current state of the system at block 270. If the answer is “yes,” the user may be prompted for user identity (“ID”) and password to recover from a power-saving state at block 275; otherwise, the system may be shut down at block 285. If the user provided the correct user ID and password when prompted at block 275, the recovery process may be started. At block 280, it may be determined whether recovery is successful. If the answer is “yes,” process 200 may go through operations at blocks 225 through 255; otherwise, the system may be shut down at block 285.

Using process 200, a computer system may be powered up or awaken through one touch by a user. The user may be directly access data in the computer system if the OS sign-on password can also be retrieved from the storage medium for the user credentials. Process 200 thus speed up the startup/wake up/data access process and also relieve for a user a burden of remembering or carrying passwords/tokens/access keys.

When a user action to trigger recovery is detected at block 210, it may be determined at block 270 whether the system is in a power-saving state and truly needs to be recovered. If the answer is “yes,” the user may be prompted for user identity (“ID”) and password to recover from a power-saving state at block 275; otherwise, the system may be shut down at block 285. If the user provided the correct user ID and password when prompted at block 275, the recovery process may be started. At block 280, it may be determined whether recovery is successful. If the answer is “yes,” process 200 may go through operations at blocks 225 through 255; otherwise, the system may be shut down at block 285.

Although an example embodiment of the disclosed subject matter is described with reference to drawings in FIGS. 1-2, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method, comprising:
attempting to access a computing system with a user action;
determining whether the user action is to start up the computing system or to awake the computing system; and
if the user action is to start up the computing system,
authenticating the user, and
if the user is authenticated, enabling the user to access the computer system.

2. The method of claim 1, further comprising if the user action is to start up the computing system,
collecting data from the user action; and
authenticating the user based on the collected data.

3. The method of claim 1, wherein enabling the user to access the computing system comprises:
accessing a storage medium that stores credentials for the user; and
retrieving a password to unlock a hard disk drive.

4. The method of claim 3, wherein enabling the user to access the computing system further comprises at least one of:
retrieving a password to start a basic input/output system (“BIOS”) of the computing system; or
retrieving a key to decrypt/reconfigure the hard disk drive.

5. The method of claim 3, further wherein enabling the user to access the computing system further comprises:
starting an operating system (“OS”) boot loader;
retrieving an OS sign-on credential from the storage medium; and
opening an OS desktop for the user.

6. The method of claim 1, further comprising if the user action is to start up the computing system and the user fails to be authenticated, prompting the user to retry if the number of retry has not reached or exceeded a predetermined limit.

7. The method of claim 1, further comprising if the user action is to awake the computing system,
prompting the user for a user identity (“ID”) and a password; and
if recovery from a power-saving state is not successful, shutting down the computing system, otherwise,
accessing a storage medium for user credentials, and
retrieving at least one of the following from the user credentials:
a password for starting a basic input/output system (“BIOS”),
a password to unlock a hard disk drive, or
a key to decrypt/reconfigure the hard disk drive.

8. The method of claim 7, further comprising if the user action is to awake the computing system and recovery from a power-saving state is successful,
starting an operating system (“OS”) boot loader;
retrieving an OS sign-on credential from the storage medium; and
opening an OS desktop for the user.

9. A computing system, comprising:
a processor to host an operating system (“OS”);
an authentication module to authenticate a user through a user action, the user attempting to start up the computing system or to awaken the computing system; and
a controller to provide power to the processor and to enable the user to access the computing system, if the user is successfully authenticated by the authentication module.

10. The computing system of claim 9, further comprising a user authentication device to detect the user action and collect data from the user action for the authentication module to authenticate the user.

11. The computing system of claim 9, wherein the authentication module is powered by an auxiliary power source that is independent from the power source that supplies power to the processor.

12. The computing system of claim 9, further comprising a non-volatile storage medium to store credentials necessary for user to access the computing system.

13. The computing system of claim 12, wherein if the user is successfully authenticated by the authentication module, the controller enables the user to access the computing system via operations including:
accessing the storage medium for user credentials; and
retrieving at least one of the following from the user credentials:
a password for starting a basic input/output system (“BIOS”),
a password to unlock a hard disk drive,
a key to decrypt/reconfigure the hard disk drive, or
credential to enable the user to sign on the OS.

14. The computing system of claim 12, wherein if the controller determines that the user action is to awake the computing system, the controller prompts the user for a user identify and a password to recover the computing system from a power-saving state.

15. The computing system of claim 9 comprises a mobile personal computer.
